(19) United States
(12) Patent Application Publication
(10) Pub. No.: US 2007/0082177 A1
(43) Pub. Date: Apr. 12, 2007

(54) Foldable chair mat

(76) Inventor: Edward S. Robbins III, Muscle Shoals, AL (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/515,571

(22) Filed: Sep. 5, 2006

Related U.S. Application Data
(60) Provisional application No. 60/724,080, filed on Oct. 6, 2005.

(51) Int. Cl. B32B 3/30

(52) U.S. Cl. 428/167; 428/156

(57) ABSTRACT

A unitary, one-piece chair mat has a substantially planar upper surface suitable for interaction with a chair support structure, a perimeter defining an outer edge of the mat, a lower surface parallel to the upper surface. The mat is divided into a plurality of areas by at least two intersecting linear separation regions. The upper surface of the chair mat, including all said areas and regions, is smoothly continuous to an outer perimeter that joins the upper surface to the lower surface. The mat is foldable in alignment with the linear separation regions to occupy an area equal to or less than one forth of the chair mat upper surface area when disposed in an unfolded planar configuration.

### CROSS-REFERENCE TO RELATED APPLICATIONS

The present application is related to and claims all available benefit from U.S. Provisional Application Ser. No. 60/724,080 filed Oct. 6, 2005.

### BACKGROUND

The present invention is directed to chair mats and specifically, to chair mats typically used under chairs in order to protect an underlying carpet. In particular, the present invention relates to a chair mat having features that enhance the ease of transport and handling, and improve marketability.

Chair mats for office and home use are well known. Chair mats that are designed to be applied over carpeting typically are formed of a semi-rigid plastic. Often an underside surface of the chair mat has an array of short spikes or other protrusions that are intended to hold the mat firmly in place on the carpeting. While chair mats can be made without any spikes, the mats tend to move relative to the carpet in response to movement of any chair on the top surface of the mat. Thus a carpet-engaging structure is deemed necessary to achieve satisfactory performance.

A typical chair mat is awkward to carry and/or otherwise handle due to its size, the semi-rigid nature of the material from which it is formed, and particularly due to the presence of the carpet-engaging features. Unless the chair mat is boxed or otherwise protected, the user typically carries the chair mat by gripping the mat about one or two of the edges of the chair mat, often resulting in irritation if not injury to the hands, due to the projecting elements from the underside of the chair mat. Commercial transport and storage of a typical chair mat is also problematic due to the same structural characteristics. The same characteristics also make the commercial display of large size chair mats awkward and uneconomical for many commercial settings at the retail level.

Attempts have been made to solve these problems by making the chair mat foldable to thereby reduce its size for handling purposes. See, for example, U.S. Pat. Nos. 4,448,625; 4,476,174; 4,784,888; 4,490,620; 5,073,428; 6,177,165; 6,183,833; and 6,284,341, each of which managed to reduce the size of the mat by half. Further, handles have been included as a portion of the chair mat to improve the ease and safety of handling of the mat. See, for example, U.S. Pat. Nos. 4,940,620; 6,177,165; 6,287,659 and 6,308,842. Generally, chair mats have been sold at office supply stores or distributors as opposed to retail stores, and to some extent, the handling problem was alleviated by boxing the chair mats individually or in groups prior to shipping. Chair mats are now being found increasingly in retail outlets, compounding the problem of safe handling. Thus, with increasing retail activity, new display schemes are also required. The last mentioned patent includes the disclosure of a retail display system designed to facilitate safer handling of chair mats.

Even when supplied from a distributor in boxed form, the physical size and other attributes of the chair mat make its handling in a retail store environment problematic in part due to the sheer size of the mats, even when folded in half. Accordingly, there remains a need for a solution to the problem of transporting chair mats easily and safely from the point of manufacture through the point of stocking and display in a retail environment to the point of ultimate use. It has been suggested in U.S. Pat. No. 6,737,150 to Zahler, et al. to create a folding floor mat which will fold in quarters, and thus occupy even less area when folded than any of the previously identified mats. The mat disclosed in the Zahler, et al. patent does not have a continuous surface within the perimeter of the mat. Instead, there is a significant discontinuity in the form of a cut from the perimeter into the center of the mat to permit the mat to fold into quarters. While such a cut might not present a problem when used directly on a hard surface floor in the environments discussed in the Zahler, et al. patent such a cut is deemed to be unacceptable for a mat to be used on top of a flexible carpet surface.

Thus, there is a need for a foldable chair mat suitable for use on top of carpeting that is foldable so as to occupy an area of one quarter, or less, of the total area covered by the mat. There is also a need for such a chair mat that is continuous within the perimeter of the mat so that it can be easily used to protect soft carpet surfaces, and that can include a carpet engaging structure which is designed for safe handling. It is desirable that these features be incorporated in a single structure having other features that contribute to easy handling and reduced cost.

### BRIEF SUMMARY

A chair mat of the present invention is intended for interposition between a carpet upper surface and a chair, and has a substantially planar upper surface that is continuous within the perimeter of the mat so that it is suitable for interaction with a chair support structure that typically includes a plurality of wheels on the lower outside points of a spider. The chair mat has a generally smooth perimeter defining an outer edge of the mat, and a lower surface parallel to the upper surface. The lower surface can include an array of projections that are preferably blunt and extend downwardly from the lower surface for engagement with the carpet. Each of the projections can have a smooth end surface spaced below the lower surface of the chair mat by a distance sufficient to penetrate into the carpet upper surface, typically by about 3 mm or more. The array of projections can be confined to a one or more selected areas of the lower surface. The array of projections can be distributed substantially continuously over the entirety of the lower surface. The array of projections resists lateral forces acting on the chair mat and thereby stabilizes the mat with respect to the carpet. The array of projections can assume any number of appearances as disclosed in my co-pending application Ser. No. 10/945,169 filed Sep. 20, 2004, which is hereby incorporated by reference. The projections can cover a majority of the lower surface of the chair mat, but need not extend to any given area including any area immediately adjacent to the perimeter.

A chair mat of the present invention is sub-divided into a plurality of areas, each area being one-quarter or less of the total area of the chair mat. The areas are separated from each other by linear regions containing a plurality of parallel intruding channels in the bottom surface of the mat that permit the mat to be folded along the separation regions. The upper surface of the mat is smooth and continuous over the separation regions of the mat, so that rollers on the bottom of a chair do not encounter any problem moving over the entirety of the mat surface. The chair mat can be sufficiently transparent that any pattern in the underlying carpet is not hidden or concealed by the presence of the chair mat. The chair mat can include decorative designs as well as the previously described lower surface features that can also be visible through the substantially transparent mat. The decorative designs can be specifically adapted to make the features making up the separation lines between the adjacent areas less apparent.

A chair mat of the present invention can be made from a suitable semi-rigid substantially transparent plastic such as polypropylene, or polyvinylchloride. The plastic needs to be sufficiently flexible to permit the bending and folding along the area-joining lines. The plastic can include static-reducing elements so long as the presence of such static-reducing elements will not significantly reduce the foldability of the mat along the linear separation regions. A chair mat of the present invention is generally divided by the linear separation regions into at least four areas, but can include five areas or six areas, and possibly even more areas may desirable in certain circumstances. The chair mats are intended to be shipped and marketed in a fully folded form to permit ease of handling by the consumer. The folded chair mat can be shrink-wrapped or otherwise packaged in a clear transparent plastic envelope. The envelope can include a handle and/or tab structures that will facilitate the handling and display of the folded mat.

One advantage of a chair mat of the present invention is a reduction in commercial space required for display at the point of sale. Another advantage is the enhanced safety provided by securely packaging the entire folded chair mat in a single enclosed envelope without any possible protruding spikes. Another advantage of a chair mat of the present invention is the ease of handling and low-cost shipping. Another advantage of a chair mat of the present invention is that the chair mat can be produced at comparatively low cost. Other features and advantages of a chair mat of the present invention will become apparent to those skilled in the art from a consideration of the following discussion that makes reference to the accompanying drawings.

### BRIEF DESCRIPTION OF THE DRAWINGS

FIG. 1 is a plan view of the lower surface of a chair mat of the present invention having four areas separated by two intersecting linear separation regions.

FIG. 2 is an elevation view taken from the bottom of FIG. 1.

FIG. 3 is an elevation view similar to FIG. 2 wherein two areas of the chair mat are being folded together along a linear separation region.

FIG. 4 is an elevation view similar to FIGS. 2 and 3 wherein the folding of the two areas is completed.

FIG. 5 is an elevation view taken from the left side of FIG. 4.

FIG. 6 is an elevation view similar to FIG. 5 wherein a pair of the areas of the chair mat is being folded against another pair along a second linear separation region.

FIG. 7 is an elevation view similar to FIGS. 5 and 6 wherein the second folding of the pairs of areas is completed.

FIG. 8 is a plan view similar to FIG. 1 of the chair mat as folded in FIG. 7, the area outlined in phantom being the former location of the chair mat perimeter.

FIG. 9 is a cross-sectional detail view of a linear separation region of the present invention taken, for example, along line 9-9 from FIG. 2.

FIG. 9a is a cross-sectional detail view of the intersection of two linear separation regions of the present invention taken, for example, along line 9a-9a from FIG. 2.

FIG. 10 is a plan view of the lower surface of another chair mat of the present invention having five areas separated by three linear separation regions, two of which are intersecting.

FIG. 11 is a plan view of the chair mat shown in FIG. 10 after the mat has been folded along the linear separation regions, the area outlined in phantom being the former location of the chair mat perimeter.

FIG. 12 is a plan view of the lower surface of yet another chair mat of the present invention having six areas separated by three linear separation regions, one of the linear separation regions intersecting the other two.

FIG. 13 is a plan view of the chair mat shown in FIG. 12 after the mat has been folded along the linear separation regions, the area outlined in phantom being the former location of the chair mat perimeter.

### DETAILED DESCRIPTION OF PREFERRED EMBODIMENTS

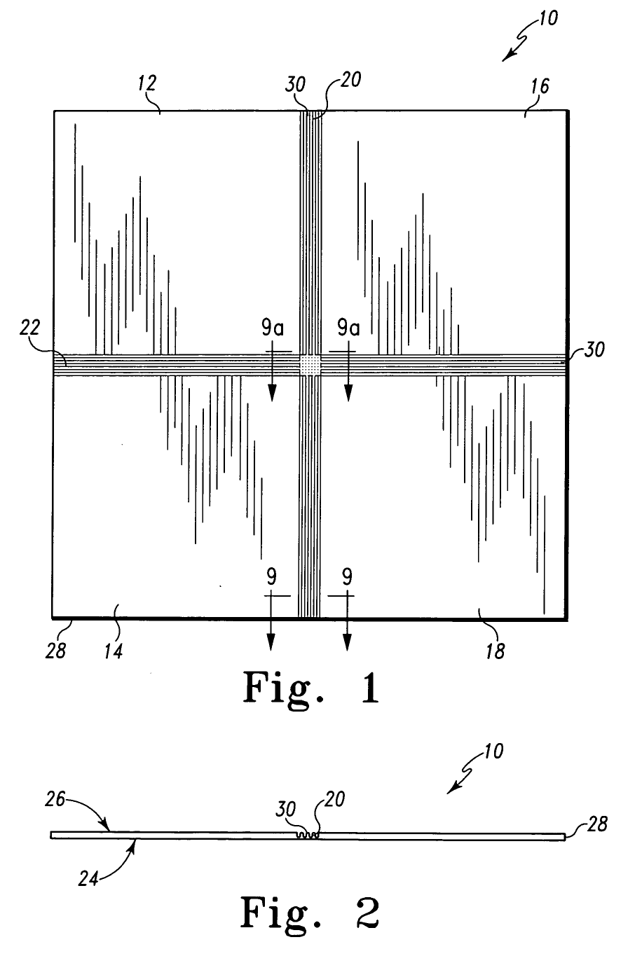

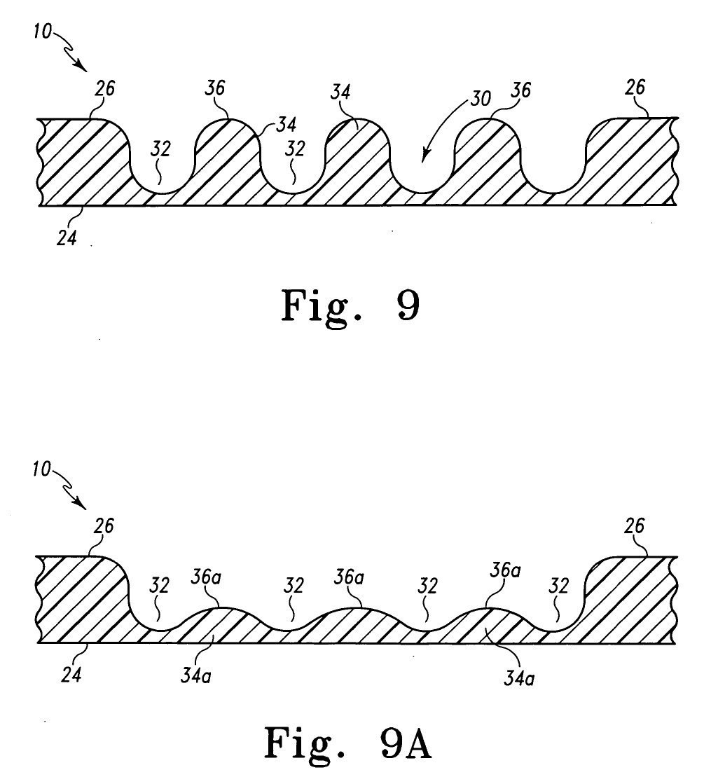

A chair mat 10 of the present invention is shown in FIG. 1 in a planar configuration to have four areas 12, 14, 16, and 18 separated by two intersecting linear separation regions 20 and 22. The mat 10 has an upper surface 24 and lower surface 26, shown in FIG. 2, meeting at an outer perimeter 28. The linear separation regions 20 and 22 can be of identical construction. The separation regions 20, 22 are generally composed of a series of longitudinally parallel grooves 30. The grooves 30 can be as shown in detail in cross-section in FIG. 9 to consist of valleys 32 that can extend more than half way through the material forming the mat 10. The valleys 32 can be separated by ridges 34 that have distal ends 36 that are substantially coplanar with the lower surface 26 of the mat 10. While FIG. 9 shows four valleys 32 separated by three ridges 34, the number of valleys and ridges may be subject to some variation so long as the series of parallel grooves 30 permits the mat 10 to be folded so that adjacent areas of the upper surface 24 or lower surface 26 can be situated in immediately adjacent confronting relationship without breaking or cracking the material forming the mat. In particular, the ridges 34 separating the valleys 32 in the region of the intersection of two separation regions 20 and 22 can be reduced in height as shown in FIG. 9a to allow easier folding.

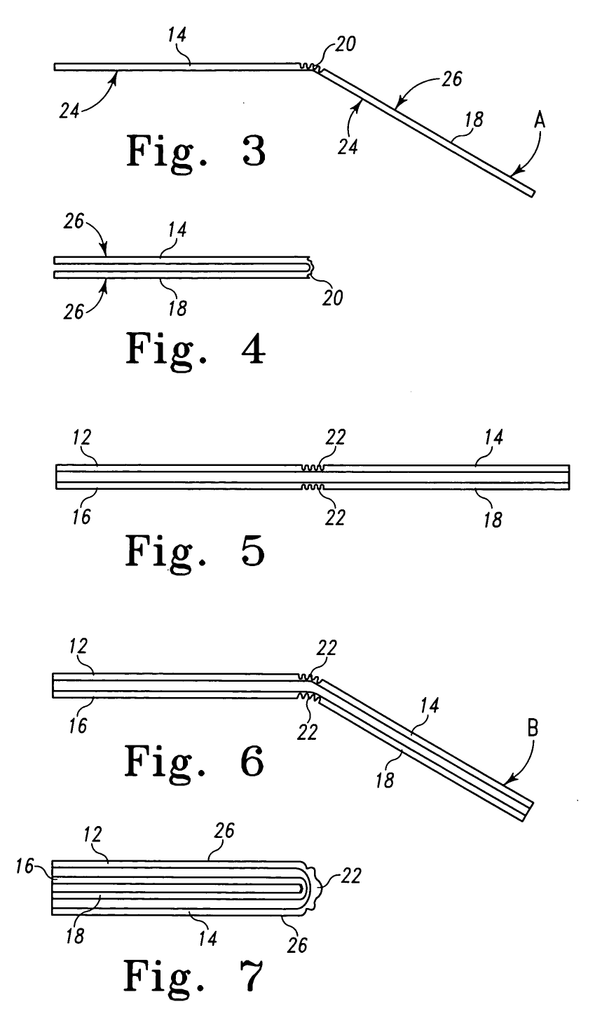

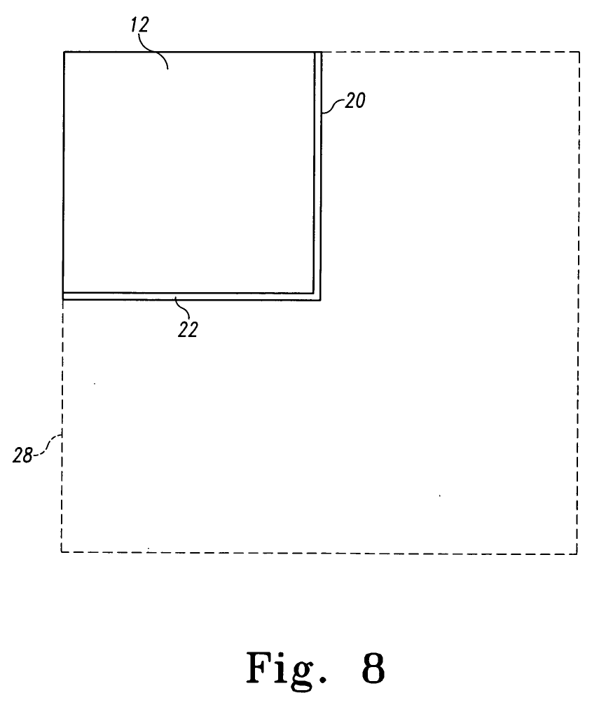

The folding operation and the resulting confronting relationship conformations are shown in FIGS. 3-7. In FIG. 3, a pressure is applied to areas 16 and 18 simultaneously to cause a rotation of those areas in the direction shown by arrow A about the linear separation region 20. This pressure is continued until this rotation brings the surface 24 of regions 12 and 14 into confronting relationship with the surface 24 of regions 16 and 18, respectively, as shown in FIGS. 4 and 5. Next, a pressure is applied to surface 26 of area 14 to cause rotation of areas 14 and 18 to rotate in the direction shown by arrow B in FIG. 6 about the linear separation region 22. This pressure is continued until this second rotation brings the surface 26 of areas 16 and 18 into confronting relationship with each other as shown in FIGS. 7 and 8. Once in this doubly folded configuration, the area presented by the mat 10 is reduced to approximately one forth of the total area of the mat, which is indicated by the phantom outline. While the illustrated folding operation results in surface 26 being the outer surface of the doubly folded mat 10, it will be appreciated that a reversal of the direction of the first fold will result in surface 24 forming the outer surface of the doubly folded mat 10.

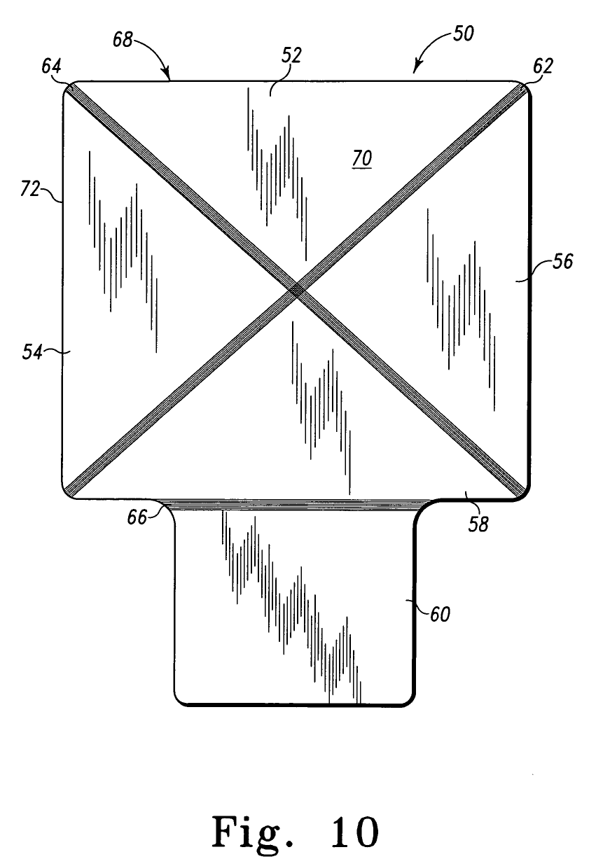

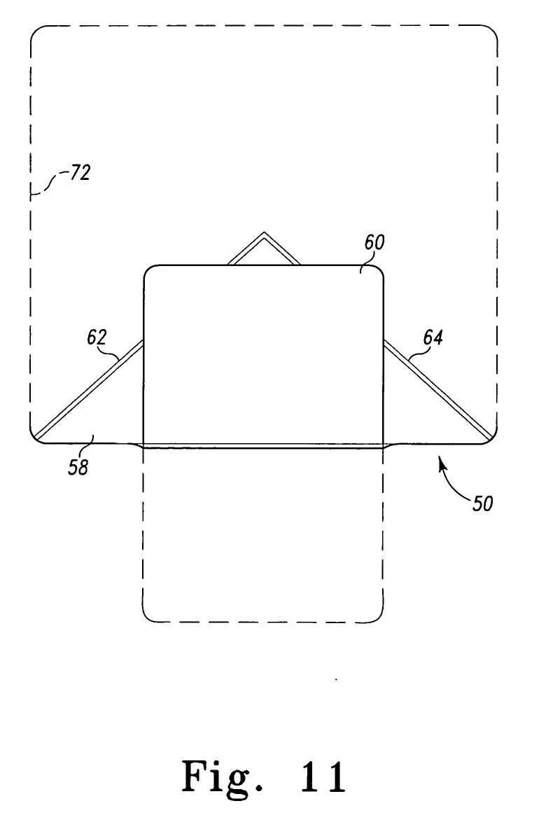

A similar folding operation can be applied to mat 50 shown in FIG. 10 to transform it from the planar configuration of FIG. 10 to the shape shown in FIG. 11. The chair mat 50 shown in FIG. 10 has five areas 52, 54, 56, 58, and 60. Areas 52, 54, 56, and 58 are separated by two intersecting linear separation regions 62 and 64. A further linear separation region 66 separates areas 58 and 60. The area 60 will be recognized as the desk well projection area of the mat 50. The mat 50 has an upper surface 68 and lower surface 70, similar to that shown in FIG. 2, the surfaces 68 and 70 meeting at an outer perimeter 72 of the mat 50. The linear separation regions 62, 64 and 66 can have a construction identical to that of linear separations regions 20 and 22 of mat 10.

A first folding operation applied to mat 50 along linear separation region 62 can bring areas 52 and 54 under areas 56 and 58, respectively. A second folding operation along linear separation region 64 can bring areas 52 and 56 jointly under areas 54 and 58. Finally a third folding operation along linear separation region 66 can bring the desk well projection area 60 over area 58. While the rectangular perimeter of area 60 would not identically overlap with the generally triangular outline of the overlapped areas 52, 54, 56, and 58, the finished area presented by the folded mat 50 as shown in FIG. 11 is less than one quarter the size of the area of the mat 50 in the original planar configuration as shown by the phantom outline in FIG. 11.

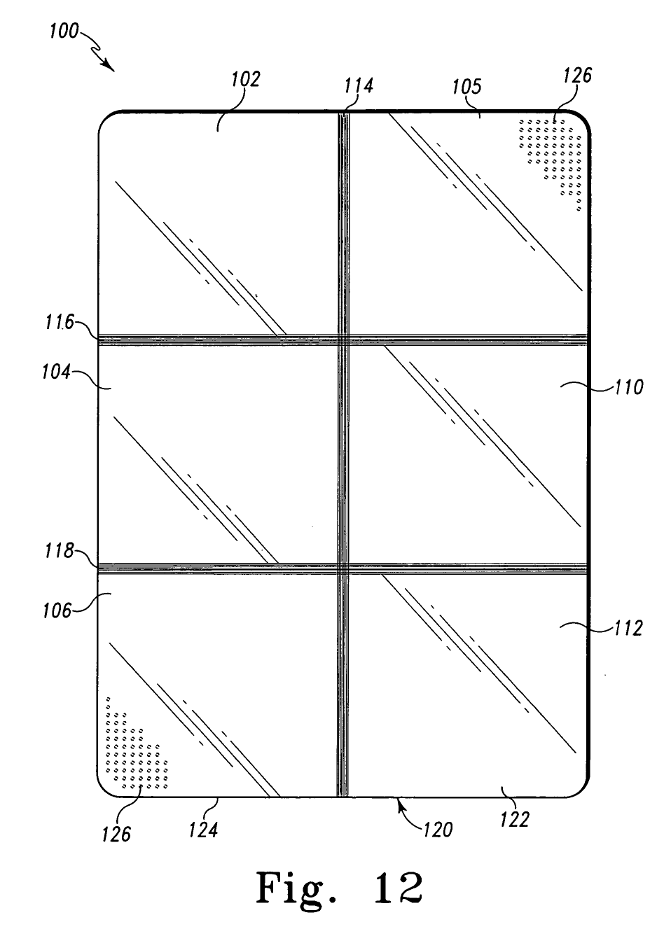

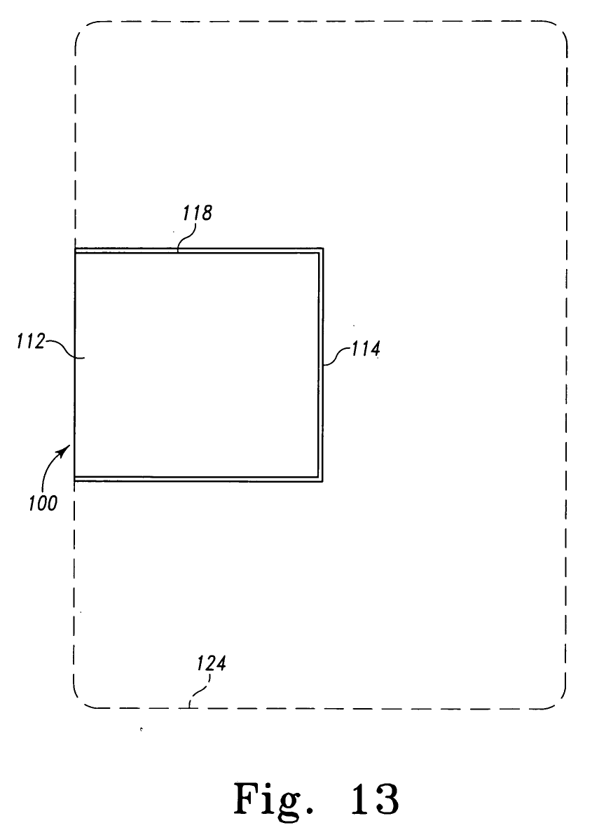

A further example of a folding mat 100 of the present invention is presented by FIGS. 12 and 13 wherein the mat 100 is shown to comprise areas 102, 104, 106, 108, 110, and 112. A linear separation region 114 separates areas 102-106 from areas 108-112. A second separation region 116 and a third separation region 118 intersect the first linear separation region 114. The mat 100 has an upper surface 120 and lower surface 122, similar to that shown in FIG. 2, the surfaces 120 and 122 meeting at an outer perimeter 124 of the mat 100. The linear separation regions 114, 116 and 118 can have a construction identical to that of linear separations regions 20 and 22 of mat 10, and regions 62, 64 and 66 of mat 50. The lower surface 122 can include an array of projections 126 that are preferably blunt and extend downwardly from the lower surface 122 for engagement with any underlying carpet.

A first folding operation applied to the planar configuration of mat 100 as shown in FIG. 12 can bring areas 108-112 over areas 102-106, respectively. A second folding operation can bring areas 102 and 108 jointly under areas 104 and 110. Finally a third folding operation can bring areas 106 and 112 jointly over areas 104 and 110. The finished area presented by the folded mat 100 as shown in FIG. 13 is only about one sixth the size of the area of the mat 100 in the original planar configuration as shown by the phantom outline in FIG. 13.

The folded configuration of the mats 10, 50 and 100 as shown in FIGS. 8, 11 and 13 present substantially improved conformations for packaging of chair mats to be used over carpeting. The chair mats 10, 50 and 100 can be shipped and marketed in a fully folded form to permit ease of handling by the consumer. Upon purchase, the consumer can easily unfold the mat and achieve a smooth continuous upper surface to support a chair over a carpet. The folded conformation of the chair mats 10, 50 and 100 can be shrink-wrapped or otherwise packaged in a clear transparent plastic envelope to permit consumer evaluation of the product in question prior to purchase. The envelope can include a handle and/or tab structures that will facilitate the handling and display of the folded mat. The folded chair mats have a continuous surface within the outer perimeter of the mat and are thus suitable for use on top of carpeting. The mats can be folded so as to occupy an area of one quarter, or less, of the total area covered by the mat when in a planar configuration. The mats of the present invention can include a carpet engaging structures 126, yet the foldable character of the mats allows for safer and easier handling.

The foregoing detailed description should be regarded as illustrative rather than limiting, and the following claims, including all equivalents, define the spirit and scope of this invention.

What is claimed is:

1. A unitary one-piece chair mat comprising: a plurality of areas separated from each other by at least two intersecting linear separation regions, the areas having upper and lower surfaces, the upper surface of the chair mat, including all said areas and regions, being smoothly continuous to an outer perimeter that joins the upper surface to the lower surface, the mat being foldable in alignment with the linear separation regions to occupy an area equal to or less than one forth the upper surface area of the chair mat when disposed in a planar configuration.

2. The chair mat of claim 1, wherein the perimeter is rectangular.

3. The chair mat of claim 1, comprising a desk well projection area.

4. The chair mat of claim 1, wherein the lower surface includes an array of carpet-engaging projections.

5. The chair mat of claim 1, wherein each linear separation region comprises at least three valleys that extend more than half way through the mat.

6. The chair mat of claim 5, wherein each linear separation region comprises ridges separating the valleys, the ridges being shorter at points of intersection of the linear separation regions.

7. The chair mat of claim 1, wherein a majority of the areas are square.

8. The chair mat of claim 1, wherein a majority of the areas are triangular.

9. A unitary one-piece chair mat comprising: a plurality of areas separated from each other by at least two intersecting linear separation regions, the linear separations region including at least three valleys separated by ridges, the ridges being shorter at points of intersection of the linear separation regions, the areas having upper and lower surfaces, the upper surface of the chair mat, including all said areas and regions, being smoothly continuous to an outer perimeter that joins the upper surface to the lower surface, the mat being foldable in alignment with the linear separation regions to occupy an area equal to or less than one forth the upper surface area of the chair mat when disposed in a planar configuration.

10. The chair mat of claim 9, wherein the lower surface includes an array of carpet-engaging projections, the mat being foldable so that the lower surfaces of two adjacent areas are in confronting relationship.

11. The chair mat of claim 9 or 10, wherein the perimeter is rectangular.

12. The chair mat of claim 9 or 10, comprising a desk well projection area.

13. The chair mat of claim 9 or 10, wherein a majority of the areas are square.

14. The chair mat of claim 9 or 10, wherein a majority of the areas are triangular.

15. A unitary one-piece chair mat comprising: a plurality of areas separated from each other by at least two intersecting linear separation regions, the linear separations region including at least three valleys that extend more than half way through the mat separated by ridges, the ridges being shorter at points of intersection of the linear separation regions, the areas having upper and lower surfaces, the upper surface of the chair mat, including all said areas and regions, being smoothly continuous to an outer perimeter that joins the upper surface to the lower surface, the lower surface includes an array of carpet-engaging projections, the mat being foldable in alignment with the linear separation regions so that the lower surfaces of two adjacent areas are in confronting relationship, the folded mat occupying an area equal to or less than one forth the upper surface area of the chair mat when disposed in a planar configuration.
